(19) United States
(12) Patent Application Publication
(10) Pub. No.: US 2023/0110929 A1
(43) Pub. Date: Apr. 13, 2023

(54) Marine Blockchain Contract and System Connecting a Vessel and Its Engine to Stakeholders

(71) Applicants: VINCENT DARAGO, BRIELLE, NJ (US); CHRISTOPHER JENKINS, PARADISE, UT (US); STACY LAABS, MESA, AZ (US)

(72) Inventors: VINCENT DARAGO, BRIELLE, NJ (US); CHRISTOPHER JENKINS, PARADISE, UT (US); STACY LAABS, MESA, AZ (US)

(21) Appl. No.: 17/964,923

(22) Filed: Oct. 13, 2022

Related U.S. Application Data
(60) Provisional application No. 63/255,321, filed on Oct. 13, 2021.

(51) Int. Cl. G07C 5/08; G07C 5/00

(52) U.S. Cl. CPC G07C 5/0841; G07C 5/008

(57) ABSTRACT

A distributed ledger system includes marine blockchain servers, a method performed by apparatuses, and communication channels between a vessel, its engine, and stakeholders. The system includes an Engine Permission Switch (EPS), a time and location service, electronic fuel (Sec) authorized by the owner, a distributed blockchain contract (Marine Blockchain) connecting a vessel, an engine, coupled to a communication channel, The engine is on only when the EPS provides electronic fuel (Sec). The Marine Blockchain has the entire history of on/off states of the engine. The Marine Blockchain encodes self-executing operating Rules. A Sec counter is decremented by time and by nautical location displacement. Unless replenished by the Marine Blockchain, achieving thresholds cause warnings, requests, and ultimately engine stop. Other warnings, requests, and engine control operations result upon the condition of divergence of vessel location from engine location, direction of travel from plan, time enroute to a destination.

### CROSS-REFERENCE TO RELATED APPLICATIONS

This application is a non-provisional application of a pending provisional application 63/255,321 Marine Configuration Blockchain and SonarGram filed Oct. 13, 2021 which is incorporated by reference including its figures and benefits from its priority date.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

The present invention relates to control over a maritime vessel and its propulsive motor by transforming location and time indicia by a smart contract encoded in a distributed ledger performed at a plurality of maritime blockchain servers into engine control indicia.

### Description of the Related Art

As is known, location and time indicia are available by radio receiver from services such as cellular radio, navigation systems, Wi-Fi, satellite communications and Naystar, Global Positioning System and Galileo satellite navigation systems. We use the term GPS loosely to refer to any similar service. As is known, block chains are distributed ledger systems that may incorporate programs to perform transactions autonomously.

As is known, quantum physics enables generation of photons by semiconductor devices from electrical potential. Similarly, electrical power may be generated from heat photons.

As is known, maritime vessels are nearly custom built with subsystems of varying specifications. Paper files and logs are generally used for configuration control, maintenance history, and surveys. Serial numbers are often hard to find.

What is needed is a way to check on status and maintenance and assure proper repairs are scheduled for insurance and safety and warranty. Furthermore, what is needed is a way to track expensive vessel systems such as outboard motors for loss prevention and insurance.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The system includes a distributed ledger at a plurality of marine blockchain servers, a method performed by apparatuses, and communication channels between a maritime vessel, its propulsive engine, owners, operators, manufacturers, maintainers, regulators, insurers, lien holders, location service providers, harbors, and dockyards.

The system includes an Engine Permission Switch (EPS), an owner interface, a time and location service, a pulse generator, electronic fuel (Sec) authorized by the owner, a distributed blockchain contract (Marine Blockchain) performed at a plurality of intercommunicated servers, contract instructions encoded into the Marine Blockchain, a Marine Blockchain connected vessel, a Marine Blockchain connected engine, a local data communication channel, and a distance data communication channel,

Systems independently have the ability to estimate and report accumulated engine hours.

The engine is on only when the EPS provides electronic fuel (Sec).

The Marine Blockchain has the entire history of on/off states of the engine.

Agreements for maintenance, insurance, finance, safety, and operation are self-executing contracts that control engine operations by budgeting the available electronic fuel for time and/or nautical displacement (how long, how far).

Loss of local contact between vessel and engine causes fall back to distance communication of location and time into the Marine Blockchain.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary environment for implementing various aspects of the invention.

FIG. 2 is an illustration of an Engine Permission Switch and its location on a vessel.

FIG. 3 is an illustration of the use model of a user panel

FIG. 4 is an illustration of a Time/Location Service and further illustrates components of the Engine Permission Switch.

FIG. 5 is an illustration to aid in understanding data flow for the Marine Blockchain system.

FIG. 6 is an illustration of data flow chart of location indicia.

FIG. 7 is a block diagram of optional components of the Engine Permission System.

FIG. 8 is a data flow illustrating an exemplary transfer of indicia to a server.

FIG. 9 discloses sources of information in a vessel.

FIG. 10 is a block diagram of one embodiment of a living motor.

FIG. 11 is an illustration of data flows leading to reporting an incident.

FIG. 12 is an illustration of data flows through processes in a vessel.

FIG. 13 is an illustration of how a system may work in a condition.

FIG. 14 is a data flow diagram of non-owner interactions.

FIG. 15 is an illustration of data flows when a motor and a vessel are not co-located.

FIG. 16 illustrates data flows among vessel and motor.

FIG. 17 illustrates data flows in the case of engine theft.

FIG. 18 illustrates data flows directed to a user panel.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

Within this application, we mean a time and location service when we use the common term “GPS”. It provides a time stamp and horizontal location on ocean surface at sea level.

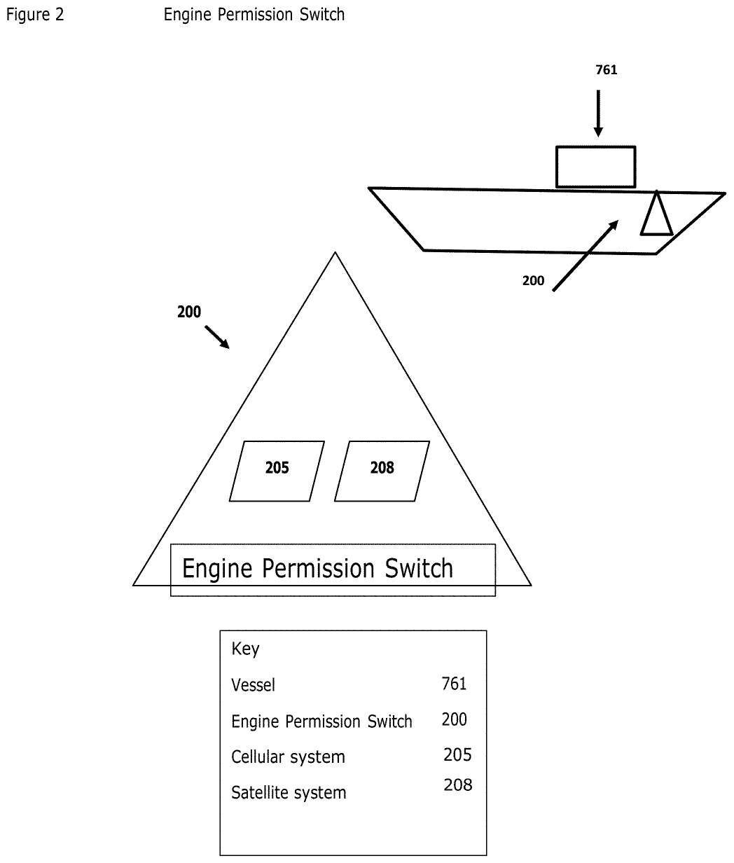

Referring now to FIG. 2, EPS 200 The EPS has a send receive cellular data unit 205. This unit, in one instance, resides upon a vessel, for example a recreational boat in a USA state or location. The EPS has a send receive satellite phone link 208.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

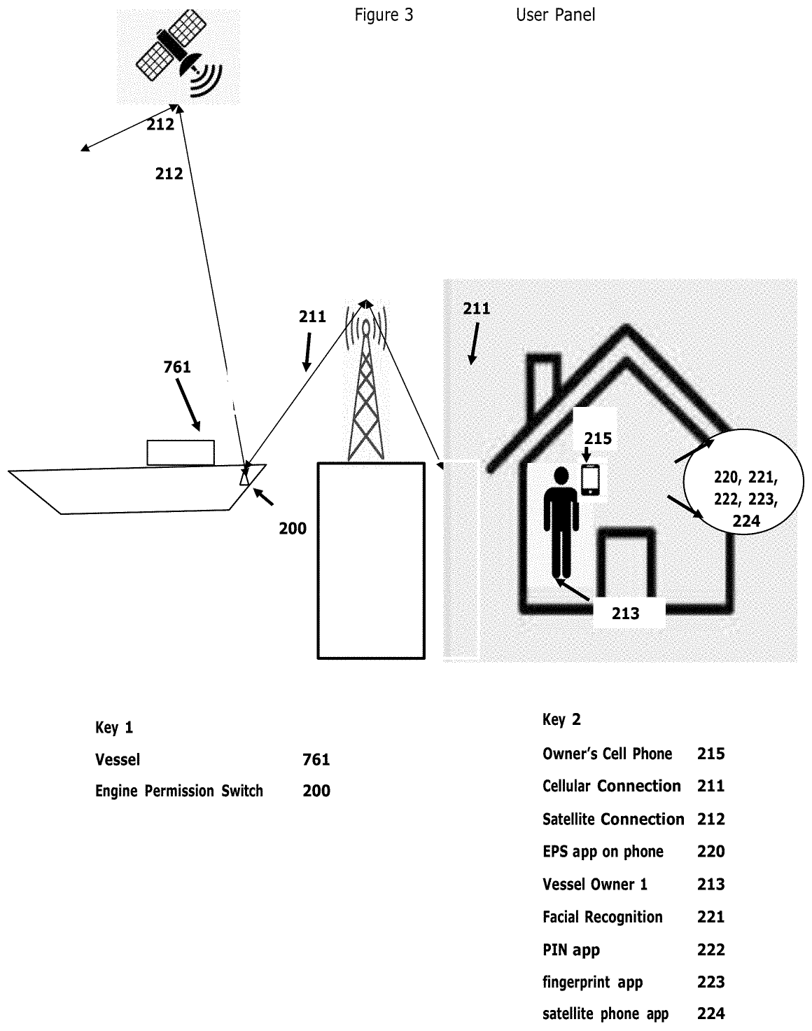

Referring now to FIG. 3, there is a flow diagram of User Panel interaction. User Panel 210 The EPS communicates with the owner of the vessel Unit 213 in one instance via a cellular connection 211 and in another instance via satellite connection 212. The owner of the vessel has a cell phone 215, employed for other uses, such as phone calls, text, navigation for driving etc. Upon this cell phone is an EPS app 220. The EPS app is protected from unauthorized use by a set of authentication permission apps, allowing the phone to recognize the phone's authorized user via Facial Recognition 221, A PIN app 222, A fingerprint app 223. The EPS app then provides special features via the operating system of the phone, the cellular network supporting the phone's communication, and the satellite phone app 224.

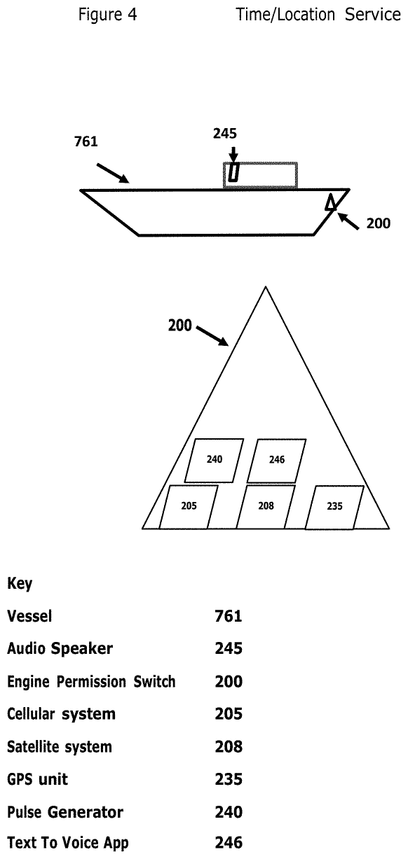

Referring now to FIG. 4, Time/Location Service 230 depends on the EPS has a GPS unit 235. The GPS unit provides location data which is transmitted to the owner of the vessel via the EPS app on the owner's phone. The EPS and the app on the owner's phone are connected via a pulse generated by a pulse generator 240 which maintains in constant contact. This pulse is transmitted by the cellular connection 211. In some instances, the pulse is transmitted by a satellite connection 212. This constant contact pulse enables the system to avoid validation by a cloned phone, which may have been trying to contact the EPS unit. The cloned phone will have a GPS location which differs from the known GPS of the vessel owner's phone.

The EPS on the vessel only allows vessel engine start, and engine continued propulsion status with electronic fuel from the owner's fuel. In one instance, the owner allows his son to start the vessel, via a similar app on the phone of the owner's son.

The app on the owner's phone allows the owner to program a number of minutes, and both radius of arc for vessel direction as well as GPS distance. GPS distance is GPS start location—GPS end location. Hence if the owner's son were to provide a destination for the vessel use permitted, the vessel electronic fuel will automatically end if the route appears to be one which makes it impossible to reach the agreed upon destination in the time proposed.

The electronic fuel end point will be well announced by an audio speaker system 245 placed at the helm, or at each helm point on the vessel. Via a text to voice app 246, the audio will announce fuel failure in advance and will begin to slow the boat in a gentle fashion. Manual helm inputs can override this slow down for safety reasons, but additional electronic fuel for an unauthorized direction or destination will only be authorized via a cellular data connection back to the owner's phone. A satellite phone connection could work as assuming the owner's son owns and carries a satellite phone. The point is the son cannot use the EPS system communications back to his father. The EPS system is text only with text to speech app to drive the speaker system on the boat.

In the case of travel beyond cell phone connectivity, a vessel's non-owner Unit 214, can either employ a cell phone with satellite connectivity to reach the owner of the vessel (the captain's father) or use the marine radio for assistance.

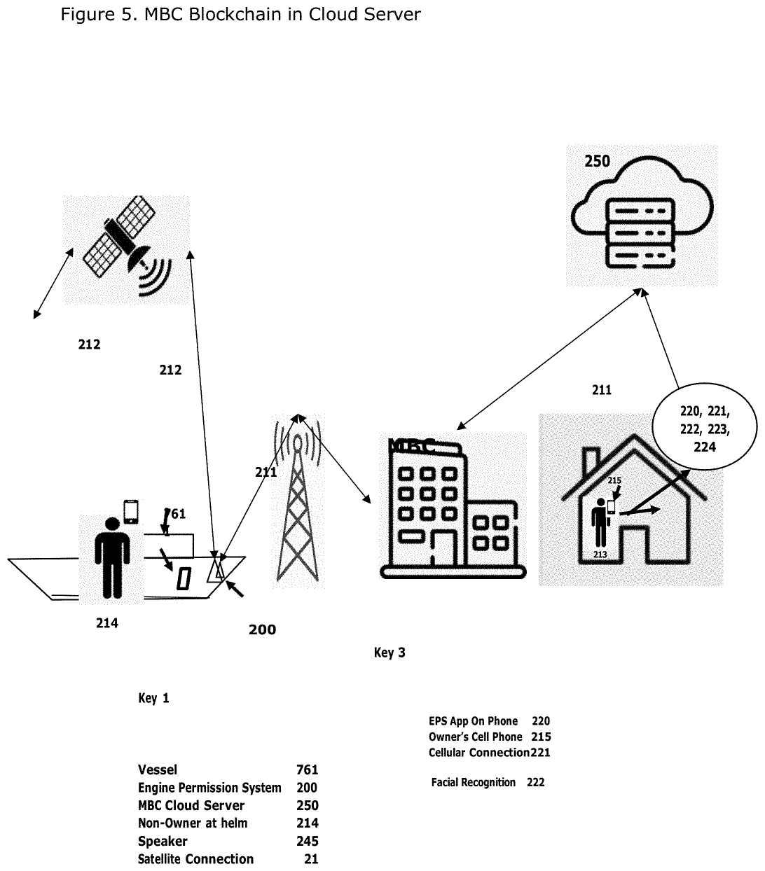

Referring now to FIG. 5, MBC Blockchain in Cloud Server 250 The EPS GPS updates are sent to the owner's phone app 220 via the MBC Cloud Server blockchain database. In this way, while the owner's phone

may be turned off,
may lose signal due to its battery running low or out, or
the owner's phone may be fine but may suffer communications interruptions due to bagging at a secure workplace, or
owner travel outside the cellular network, notwithstanding all the possible failure modes of the owner's phone or the owner's communication link, the owner's instructions to his son is relayed to the EPS unit on the owner's boat via the MBC blockchain system in the cloud.

In this way, the agreed upon direction of travel and length of travel, and other details such as the speed of travel is maintained via continued electronic fuel provided by the host MBC system even if the vessel's cell phone remains in touch.

A non-owner at the helm will not receive electronic fuel beyond the owners last instructions to the MBC Cloud Server, even if the non-owner at the helm is in touch with someone else.

Living Motor Living Motor 270 There are anti-theft advantages to the use of electronic fuel in addition to gasoline, oxygen, electric spark and other more traditional requirements for engine propulsion.

Rather than deny the engine any of the traditional components feeding the engine reaction that produces power, via some hidden off switch, the requirement that the engine now requires electronic fuel means that if a thief were to find the MBC EPS unit and disconnect it from the vessel, or from the engine (s) on board the vessel, the engine (s) would not start, making theft of the boat more difficult, (it would require a towboat to complete the theft) and making resale of the engines less desirable. In one instance of this EPS system the manufacturers of boat engines license this patent and arrange their engines to seek this electronic fuel as an option available to be set by an authorized dealer,

### MBC Connected Vessel

MBC Connected Vessel 290 The MBC Connected Vessel provides opportunities for

decreased insurance premiums,
increased boat safety and
increased boat lifespan and
boat resale value.

Currently, boats of a certain age, perhaps 7 years old, and of a certain market or insured value, and of a certain manufacturer and model may fail to be reinsured, unless there is a marine survey of the boat.

Even then, failure of a timely final report from the marine surveyor's office could create a loss of boating days, while the boat is offline waiting for the survey results. In some cases, at some marine insurance carriers, two or three years of “up to date” MBC maintenance and other boat features and facts may be permitted to substitute for a new marine survey.

In another instance, if the insurance policy requires insurer access to the boats MPC real time history, the insurance company may, if this action appears in their mutually signed coverage agreement with the vessel owner, the insurance company may deny electronic fuel to this vessel until certain survey recommendations have been completed by a competent repair facility.

Further, the owner of the boat may authorize MBC to deny electronic fuel to the boat whenever a manufacturer's recall is of a level of seriousness that use of the boat could create a risk of injury to the owner or the owner's family. Therefore, there can be owner contracted situations, with owner's full knowledge, where the MBC EPS would deny start up of the vessel, even if the owner desired the start up.

The owner, could, of course, change this direction to the MBC EPS system. As the owner of the boat, the owner has complete control of the MBC EPS system, with the exception of legal requirements, such as contract language in the owner's signed insurance agreement.

Similarly, owners may find financing a used boat is easier with the boat being an MBC connected vessel. This could be due to the extensive owner's maintenance records regarding the last three years of boat maintenance history.

From the viewpoint of the lender, if the owner is a borderline economic risk the lender may require an automatic “repossession of the financed boat” via the MBC system denial of electronic fuel due to non-payment of a loan payment when due. In such case, the owner would not be able to start the boat without lender release sent to MBC in a legal manner.

An MBC connected vessel may receive emergency broadcasts via a speaker, item 245, on the vessel in the case of fast-moving adverse weather conditions. No doubt, every boat owner is well versed in weather, and is aware of weather as predicted by weather agencies, and from both personal observation and devices which may be on board, however, since many recreational vessels are used for enjoyment, distractions on board may cause an MBC audio alert via, item 245, to be the first call to action regarding a deteriorating weather condition.

If a captain were to become incapacitated, an MBC connected vessel could be piloted by MBC if there were a navigation system on board the vessel and if the owner of the boat were to direct MBC to do so.

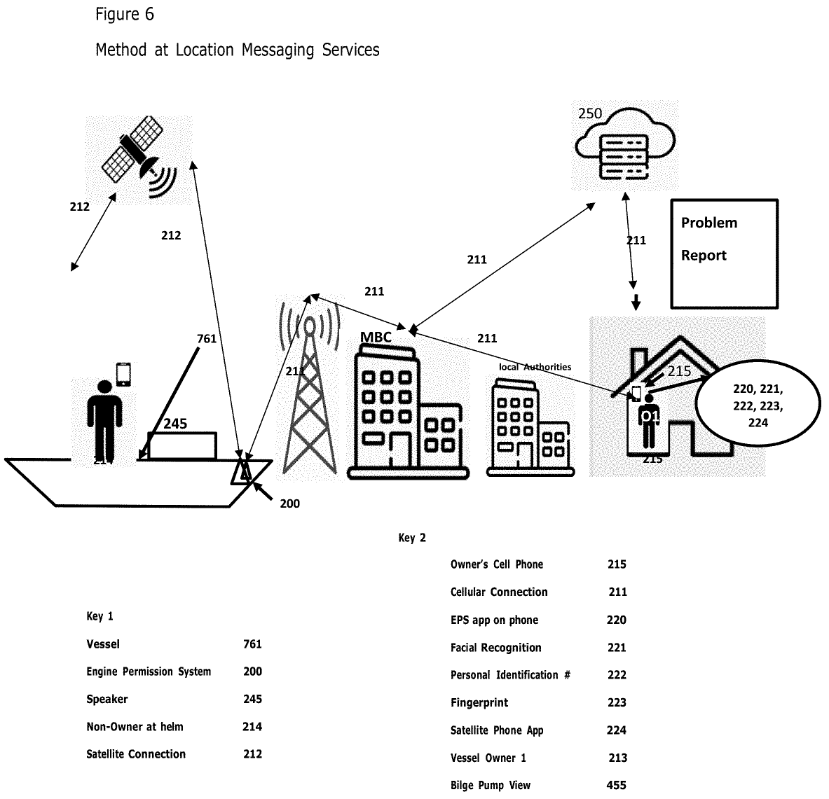

Referring now to FIG. 6, the MBC EPS unit has a list of authorized users. For example, if a vessel's mechanic were an authorized user of the EPS unit, the mechanic would tell the owner that he needed to move the boat. The owner could program the EPS via the customer interface (in this instance the owner's cell phone) to direct the MBC database to transmit GPS for the boat at a rate (such as a new GPS location each minute) to be determined by the owner of the boat at the time of service. If the boat were to be seen leaving the dock when this was not understood by the owner of the system to be part of the mechanic's (non-owner Unit 214) expected task, the owner could request MBC deny electronic fuel in a way consistent with boat and boater safety. This request would go from the customer interface, in this instance cell phone Unit 215, to MBC via cellular traffic, from MBC to the MBC Cloud Server Unit 250, from the Cloud Server to the MBC office, from the MBC office to the EPS Unit 200 on the boat.

If the mechanic does something that results in a different GPS sent back from the EPS 200 unit to the MBC Cloud Server, the Cloud Server will send a text to the EPS 200 to play an audio message on Unit 245 at the helm of the boat. The message to the mechanic will be the engine will stop in X minutes, per the owner's instructions to the MBC Cloud Server earlier when the mechanic asked permission to test the engine. At a time in the first message to the MBC Cloud Server from the owner, the mechanic will receive an audio message that the engine will shut down after an audio count down. Receive “ran out of SEC” 330 consistent with boat and boater safety is a shut down of the engine (s) which is not abrupt but can take place with the audio warnings described above, via unit 245, preceding the engine shut down.

Transmit problem location to MBC 390 If a

captain was to become incapacitated,
or a tracked lifesaving subsystem on the boat were malfunctioning
for example, the bilge pump on a vessel
1. has a pattern of on off use, and
2. a pattern of length of system on each time it comes on,
3. as well as a common or usual draw of AMPS,

if any or all of these measures (1., 2., and/or 3. above) were to change from long standing MBC data stored on this bilge pump, the MBC system could deduce a possible leak of seawater into the bilge sooner than the captain or crew or guests on the boat, especially

1. if there was music playing on the boat, or
2. if everyone got off the boat to go swimming,
3. have a picnic, or
4. leave the boat to have lunch while the boat is docked.

Once a bilge anomaly is deduced via the Bilge Pump View Unit 455 MBC can Transmit problem location at known GPS to marine and other local authorities by the MBC server system as well as a description of the vessel,

manufacturer,
model,
year,
boat name,
boat hailing port,
length of vessel
GPS location of boat.
Same if the vessel were stolen, and consequently disabled by the EPS.
manufacturer,
model,
year,
boat name,
length of vessel
and GPS location of boat.

Each member of the MBC system, where a member is typically but not exclusively a boat owner, enters a boat into the MBC system. The MBC system (data entry URL via the owner's cell phone is the Customer interface with the MBC system) which requires the HIN, or Hull Identification Number as well as the name of the boat, in order to proceed to create the first entry in the MBC system.

Each HIN number input into the MBC system is automatically deposited in an MBC database available to MBC AI for analysis
The HIN number contains 12 characters So take an example HIN number of 12 characters Example: ABC12345J314
In the HIN number of ABC12345J314 our AI can determine
1. The manufacturer (ABC)
2. The year of manufacture (J314)
3. The model of boat (there is a free online system which will give the model of the boat from the HIN, MBC recommends all owners confirm the model of the boat, especially if it was purchased used)
4. With the Manufacturer, year and model of the boat, MBC AI can determine the length of the boat.

### Method at MBC Cloud

Receive more SEC 410. Proper authorities would have an interface to the MBC server system. Proper authorities could communicate with the MBC server system yin one instance via the MBC office and in another instance with the owner's permission via the owner's cell phone or other MBC interface, receive electronic fuel for starting engine.

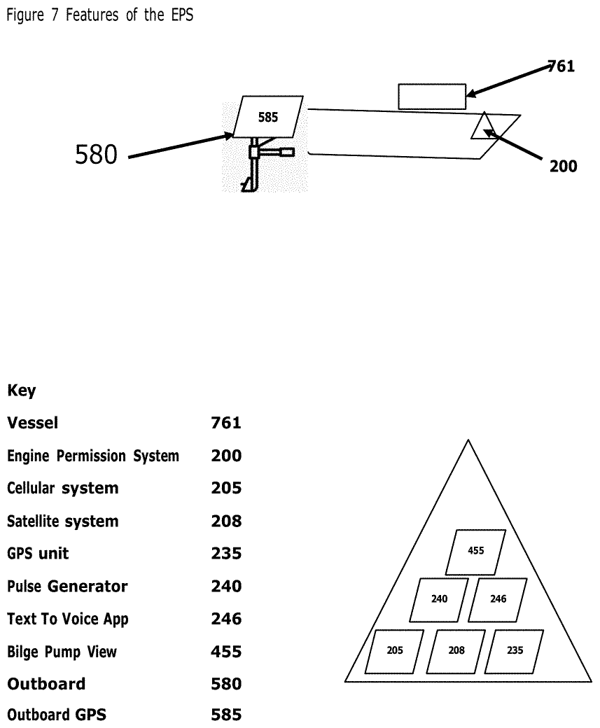

Referring now to FIG. 7, Authorities would message endpoint location for storage of the boat until released after cleared by evidence collection teams or other legal authorities.

MBC server could compare GPS of vessel transmission with the given endpoint provided by authorities and allow the vessel to proceed, or to be shut down by MBC if the vessel took a route impossible to be consistent with the endpoint reported by authorities.

Add to MBC 430 A key outcome of the polling between the EP unit and the accompanying GPS location with each polling update, gives the MBC system two different systems, each of which independently has the ability to estimate engine hours via this polling mechanism.

All polling reports with identical GPS suggest a vessel at the dock, with no consideration for on or off engine. Engine on while at the dock, for maintenance for example, would be very low relative to engine hours due to moving from point A to point B. Nevertheless, due to the EPS server accounting for minutes of use, to deploy corrective action if the vessel is not going where it was reported it was going, the EPS server has a very good estimate of engine hours on each trip.

The engine is on only when MBC EPS provides electronic fuel. Due to the pulse generator 240. MBC Cloud Server 250 has the entire history of on/off states of the vessel engine (s). Simple addition or cum of all on-state pulse generation traffic will give the total number of engine hours.

From time to time, maintenance on the engine will involve a scan of the engine. A scan of the engine will reveal engine hours as commonly referred to in the trade. These scan results can be compared with MBC data and anomalies reported.

From time to time, the owner will take a picture of his/her boat's engine hour gauge. This picture will in most cases be uploaded

into the MBC Cloud Server 250. The MBC system has features to make it easy for MBC customers to highlight key information to make sure Al will recognize this key data.

Thus, the MBC system has four features that result in engine hours of use ⋅From time to time, the owner will take a picture of his/her boat's engine hour gauge. ⋅From time to time, maintenance on the engine will involve a scan of the engine. A scan of the engine will reveal engine hours ⋅Simple addition or cum of all on state pulse generation traffic will give the total number of engine hours. ⋅Due to the GPS pulse traffic to EPS cloud server the EPS server has a very good estimate of engine hours on each trip, adding all trips together results in an estimate of total engine hours.

Respond to vessel 450. One of the MPS EPS tracking systems, Bilge Pump View Unit 455, is watching bilge pump activity. Frequency of bilge on activity is monitored. AMP draw of the bilge pump is monitored. ⋅Frequency of bilge pump on off cycle. A given vessel will have a pattern of bilge pump on activity. The pattern will be affected by time since last hull reseal, etc. Unusual bilge activity can predict bilge failure, or bilge overload due to vessel damage or other situations taking on high water loads.

typical and atypical current in Amperes (AMP)draw due to bilge pump use. A failing bilge pump will pull a different AMP load off the electric system on the boat. Changing or anomalies in AMP readings can predict, or indicate bilge pump failure.

A bilge pump anomaly or failure detection can be an agreed upon DANGER situation per an agreement between the MBC customer and MBC. In such a pre-agreed upon definition of DANGER, MBC can send messages to ⋅local safety authorities if the vessel engines are on, ⋅to local marina staff if the vessel is docked, and ⋅again to local safety authorities if the engine is off, but the vessel GPS is shown to be near no docking or logical anchoring location.

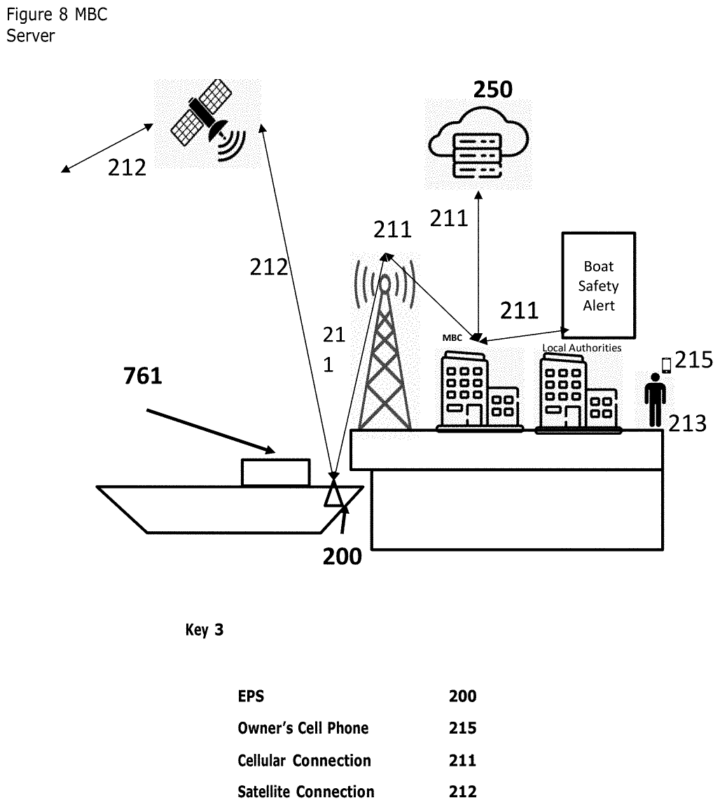

Referring now to FIG. 8, The MBC Cloud Server Unit 250 has many features, many of which are supported by special user interface, in one instance this is a URL on the vessel owner's cell phone, Unit 215, There are instances where the owner is encouraged to highlight certain key data upload files. The MBC cloud server (unit 250) system has a feature set to collect information on

All boats owned by a particular MBC customer ⋅Where each boat owned is identified by the owner with a HIN and a boat name.

The owner is encouraged to upload all maintenance proof to Unit 250 ⋅Photos ⋅Invoice Documents ⋅Receipts of purchase ⋅Added equipment ⋅Replaced equipment after damage or failure to a subsystem ⋅Survey reports

The owner is encouraged to do this to ⋅Have a complete inventory of value in case the boat is declared a loss ⋅Have a complete inventory of systems in case the boat suffers an incident wherein a thief removes one or more systems ⋅Have a complete list of systems ⋅And a complete value of systems listed ⋅And a complete electronic copy of all maintenance, additions, and upgrades to share same with potential buyers at a time of sale

### Spacetime Store.

The MBC spacetime store is available for use by any MBC customer for any and all boats owned by an MBC customer. At the MBC space time store, the MBC customer can set rules for himself, as well as for any and all non-owner captains permitted to helm the boat or boats owned.

In the case of a boat rental, the owner can set a space time rule that the customer may no longer travel away from the endpoint dock, if such travel makes it impossible or unlikely that the boat will be returned to the agreed upon dock at the agreed upon time

In the case of a leased boat, the lease agreement may have rules pertaining to enforced time elapsed or mileage elapsed where the lessee must have an oil change performed, and that the oil change proof must be uploaded to a folder which has been provided viewing rights to the lessor of the vessel.

Lessee and lessor are legal terms that are widely used on rental agreements and lease terms. A lessee is the party who rents property from the lessor. A lessor is the party who rents something out.

In the case of the owner of the boat allowing other members of his/her family to captain the boat, DANGER rules may be agreed upon and entered into the MBC Cloud Server System so that the owner does not need to be reached in real time in order for the MBC Cloud Server system 250 to take protective action. For example, if the bilge pump shows an anomaly, the owner of the boat may instruct protective action be taken, even if the owner can not be reached.

In such events, the captain may be instructed to return to dock, or the nearest safe harbor, while at the same time maritime safety authorities are informed of GPS and boat visual identification items. (Again, all these actions would be taken only if the owner of the boat preloaded these instructions into the MBC Cloud Server System via the customer interface.)

### SEC Store

Location of Vessel Due to a GPS system (unit 235) within the EPS system the location of the vessel is always known to the MBC Blockchain Cloud Server (Unit 250)

### Connect to Vessel 671

The MBC Cloud Server will remain in touch with the vessel whenever cellular data is sufficient to continue the receipt of pulse generator generated pulses. Only if an MBC customer purchased the premium package will MBC continue to receive pulses via satellite connectivity.

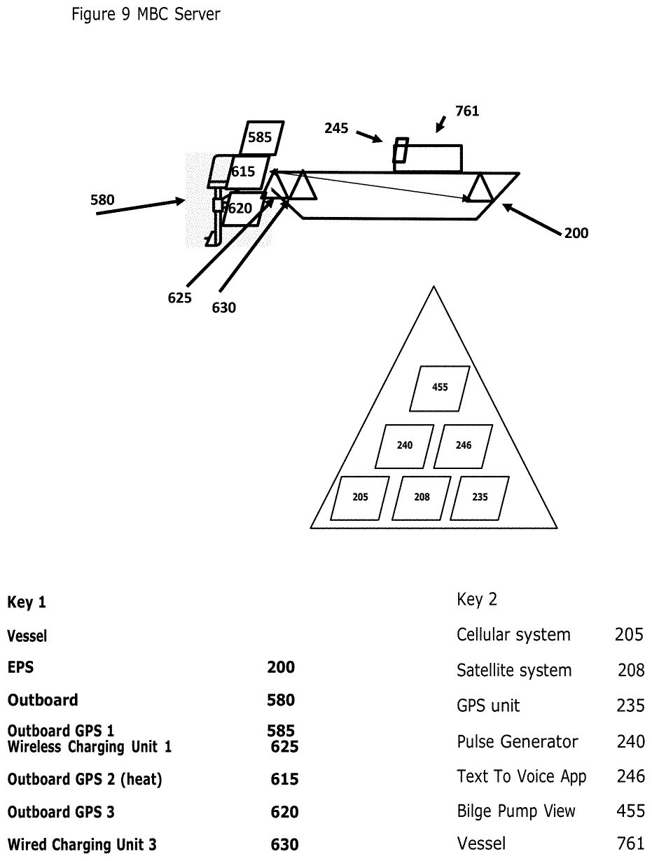

Referring to FIG. 9. Due to one of three options, 1. GPS unit 585 2. GPS unit 615 or 3. GPS unit 620 on 1. The Motor mount or on 2. The interior of the cowling or 3. On the exterior of the cowling of an outboard motor Unit 580 See GPS Unit mount in FIG. 9 Interface to vessel 590 GPS unit 615 is placed under the cowling in one instance by the manufacturer and in another instance by a qualified dealer for this engine and in another instance by the owner after the warranty period for the engine has expired. It recharges the battery unit as the heat capture system captures heat from the running engine. The GPS system then communicates to the EPS Bluetooth Unit 248 on the vessel via a Bluetooth system associated with the GPS system. GPS unit 585 is placed on the support bars between the engine and the boat in one instance by the manufacturer and in another instance by a qualified dealer for this engine and in another instance by the owner after the warranty period for the engine has expired. The battery unit recharges as the system captures electricity from the wireless charger Unit 625 placed close to the support bar inside the hull. The GPS system then communicates to the EPS on the vessel via a Bluetooth system associated with the GPS system.

GPS unit 620 is placed on the support bars between the engine and the boat in one instance by the manufacturer and in another instance by a qualified dealer for this engine and in another instance by the owner after the warranty period for the engine has expired. The battery unit recharges as the system captures electricity from the wired charger Unit 630 placed close to the support bar inside the hull. A physical wire runs from Unit 630 to 620. The GPS system then communicates to the EPS on the vessel via a Bluetooth system associated with the GPS system.

### Heatup 610 Three Systems for Charging GPS on Board the Outboard Motor

Placing a GPS unit on the cowling of the engine itself, (Unit 615) or inside the cowling of the engine if this does not void the warranty, will subject the Unit 615 GPS unit which is upgraded to turn heat into electricity, this GPS unit 615, has circuity allowing the GPS unit battery system to be replenished whenever the outboard engine is on long enough to produce heat.

Placing the GPS unit on the Outboard engine mounting bracket will place the GPS unit 585 very close to the boat hull structure and this is a placement allowing the battery system to be powered up via a wireless charging system UNIT 625 at the boat hull. ⋅As the Outboard system (unit 580) is designed to stay with the boat unless there is major maintenance or replacement, the Outboard Motor (GPS 620 is designed to be charged via wired charger system Unit 630) battery can also be powered and charged via a wire from an onboard charging unit

Receive location in SpaceTime 640 The GPS on the Outboard Motor is designed to do two things 1) Provide an alert when the GPS 585 or 615 or 620 of the Outboard Motor Unit 580 does not report the same GPS as the vessel GPS Unit 235. Such an anomaly report suggests the engine has been removed from the vessel. 2) The battery in GPS Unit 585 or 615 or 620 will continue to report GPS location after a theft via either an onboard data system seeking Wi-Fi, or in the case of an expensive Outboard Motor or set of Outboard Motors, via an onboard cellular system, or satellite system. Store baseline Space Time & Location (SEC) in counter 650 SEC Counter 650 resides onboard the MBC Cloud Server (Unit 250) The cloud server is counting pulse segments generated by the Pulse Generator (Unit 240), as all pulses generated are sent at the same time interval, the counting of pulses, by the MBC Cloud Server provides time at a location, or time enroute towards a given location. Count down 670. The count down times held by the MBC Cloud Server are times provided by the owner of the vessel, for example, the son of the owner may have time T=TIME as calculated by the server to reach the destination set up by the owner for this trip after his son gave a proposed destination.

The owner (the father) may be out of touch for whatever reason, however the MBC Cloud Server will continue with the owner's instructions, including, if needed, the shut down of the vessel engine (s) if the vessel GPS shows a significant deviation from the destination proposed.

Compare SpaceTime with baseline 673 However, if the boat is out of touch with the MBC server, the on-board EPS will continue to count down, and will turn off the engines at the time estimated to be the arrival time at the proposed destination.

Decrement by delta spacetime 675 Warnings 677 Should the on-board EPS elect to shut down the engine (s) an audio waring will be heard via the speaker system (Unit 245). Request more SEC 679 Only an update from the owner of the vessel to the MBC Cloud Server would enable the EPS to provide additional minutes of engine use. Shutdown ignition 690

The shutdown of the engine will take place via ⋅Deny fuel ⋅Deny spark ⋅Deny electronic signal ⋅Physical brake for engine motion

When a shutdown takes place, it is always done over a period of time, with audio warnings via UNIT 245 any slowing of the engines can be overcome for brief periods for safety, but the eventual result will be engine shutdown until new instructions are received by the boat owner.

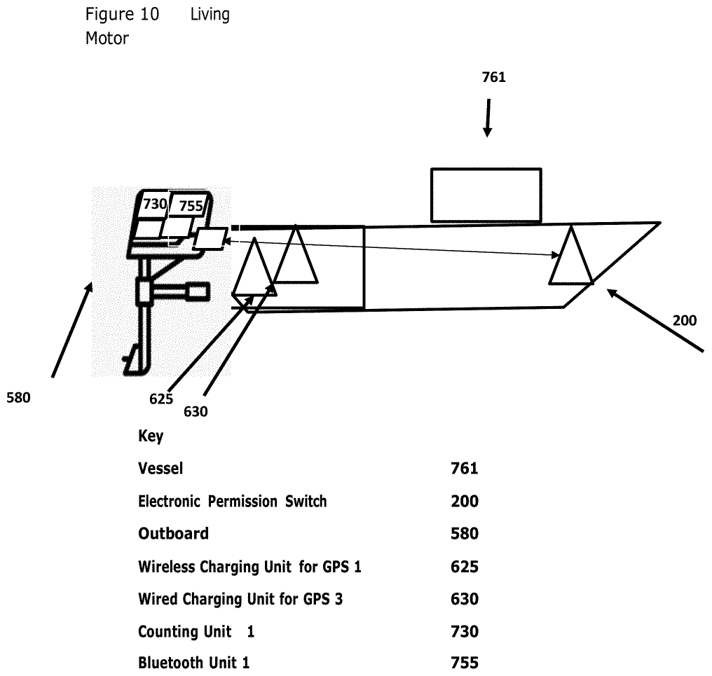

Referring now to FIG. 10, in illustration of the living motor data flow includes: A counter unit on board the engine (or engines) Unit 730. The advantage of an integrated counting unit on board the engine (or engines) is that as the engine is used, the counter reservoir of minutes will deplete, and the engine will stop permanently, unless it is reconnected to the MBC system, and the appropriate MBC customer.

Interface to Vessel 750 The interface to the vessel 761 is via a Bluetooth connection Unit 755). The beauty of use of a Bluetooth connection is that Bluetooth only works over short distances. Once the engine (or engines) is/are removed from the vessel, no update of additional time for engine on setting will take place as the Bluetooth unit goes out of range of the EPS.

Ignition Control 770 The ignition control of the engine will take place via the following steps ⋅The Owner gains access to his phone via security choice such as Facial Recognition, PIN, Fingerprint, etc. ⋅The Owner opens and signs into the MBC ESP APP ⋅The Owner seeks the engine control portion of the MBC ESP APP ⋅The Owner choses to turn the engine on/off ⋅A cellular data signal passes to MBC, ⋅From MBC to the MBC Cloud Server ⋅From the MBC Cloud Server to the Electronic Permission System (EPS) on the Owner's vessel ⋅From the EPS to the engine ⋅The engine starts/stops as selected in the MBC ESP APP

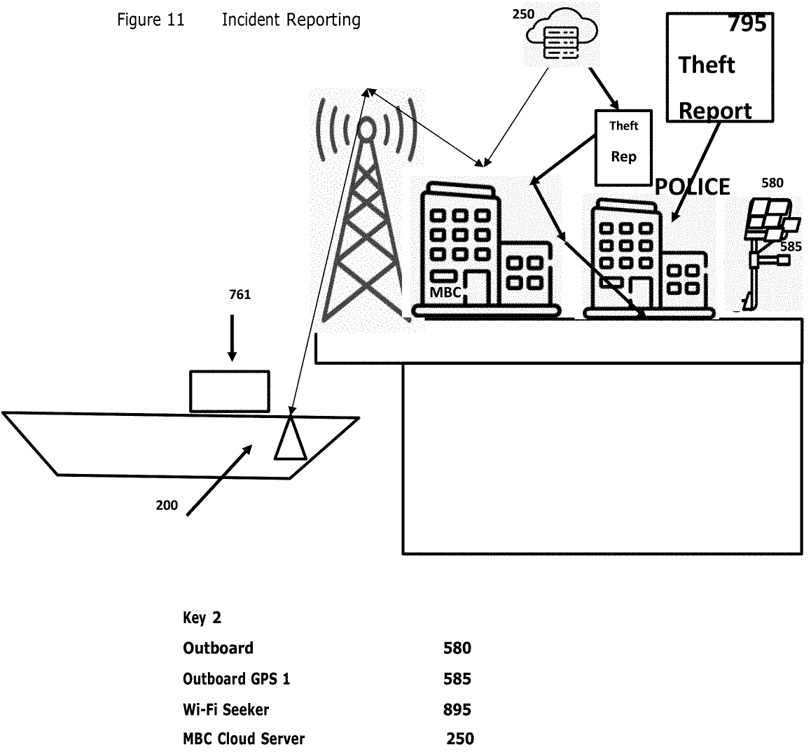

FIG. 11 is a data flow illustration of a condition whenever an anomaly is reported where the engine is separated from the vessel, MBC reports this anomaly to the owner of the vessel. If a predetermined report has been selected and approved for release to local authorities by the owner of the vessel, MBC will also provide a report to local authorities. Report 795 is generated.

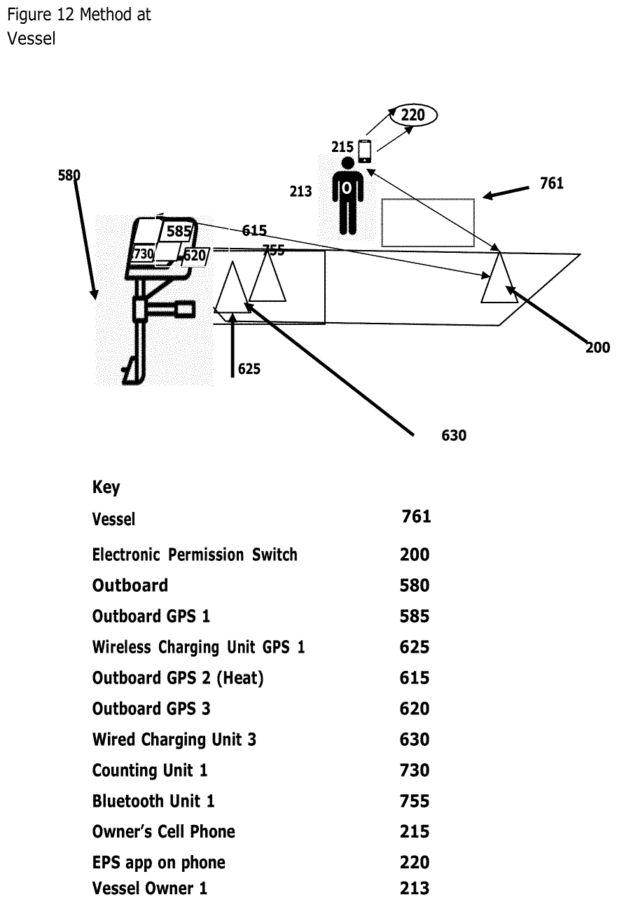

Referring now to FIG. 12, a data flow diagram illustrates the components which provide connectivity at the vessel to the owner.

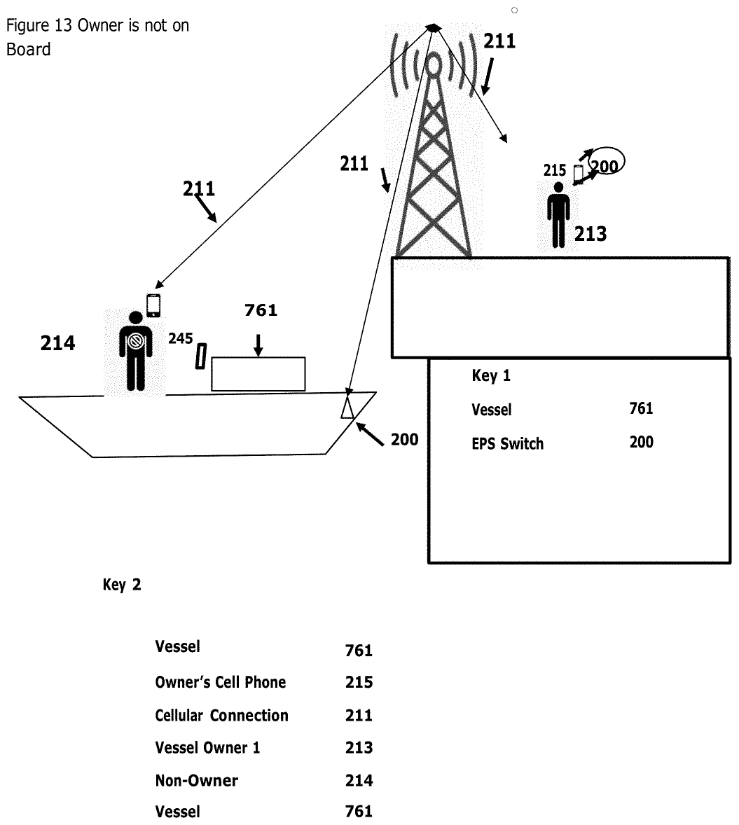

Referring now to FIG. 13, in an embodiment, the system includes Data flow when the owner is not aboard.

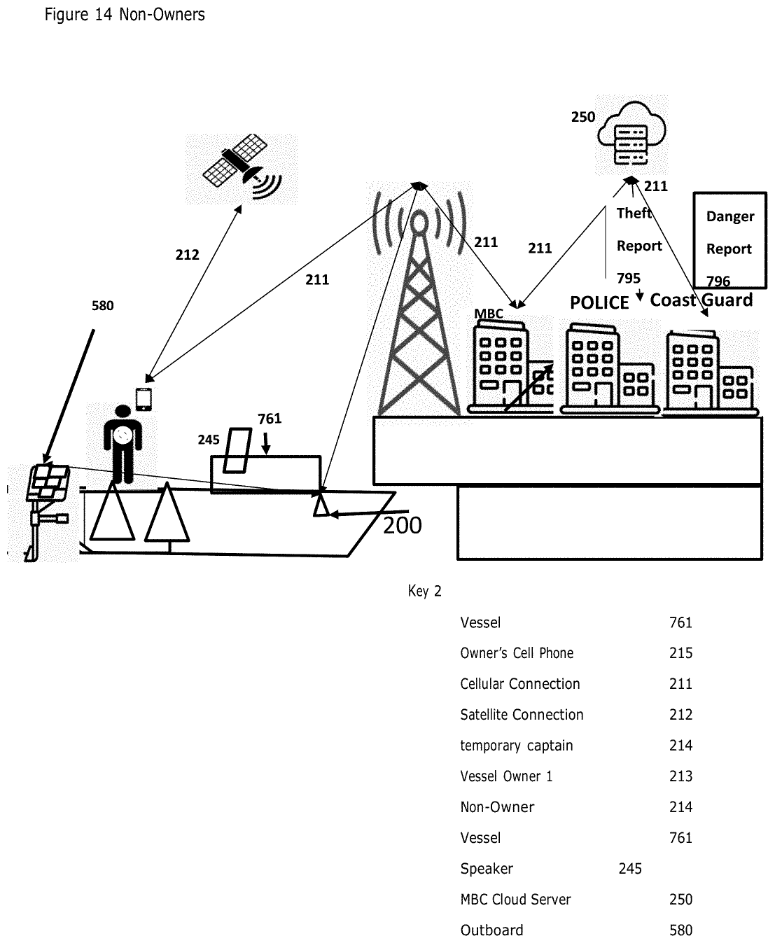

Referring now to FIG. 14, in an embodiment, when an owner is not aboard the vessel, If the engine is associated with the vessel, the steps for additional engine on time are as follows: 1) Instance A, the owner is on board the vessel, in this case the owner has his cell phone. ⋅Owner selects the MBC EPS app on his phone ⋅Owner provides additional minutes of use to the engine (s) via the EPS system on board the vessel over a cellular data connection. The EPS provides the owners instructions to the engine (s) via Bluetooth. 2) Instance B, the owner is not on board the vessel 761, in this case the temporary captain 214 must contact the owner via the temporary captain's cell phone. ⋅If the captain's cell phone can reach out to a cell tower (cellular connection 211, the captain calls the owner 213, and requests more “engine on time”. ⋅If the captain is on course and on time towards a GPS location that the captain and the owner agreed was the appropriate destination for this trip, and if the captain does not reach the owner, the MBC Cloud Server will elect to provide more minutes, even without a new confirmation from the owner. The MBC Cloud Server will continue to implement the last directions from the owner. 3) Instance C, whoever is at the helm of the vessel 761, the owner's son, a captain associated with the owner, a non-authorized person, all the above are non-owners (214).

If the vessel is not heading towards the last GPS associated with the owner's directions, the MBC EPS system (200) will slowly decrease speed as the minutes of use decrease. Audio announcements via speaker 245 will inform the person at the helm that the engines will fail shortly and give an accurate audio countdown of minutes before the engines stop via speaker unit. For safety reasons, the helm will take an input to increase speed as the vessel may need to avoid a collision, however increased speed will increase the speed of the countdown as well. Whoever is at the helm may call the owner via cellular (211) or satellite connectivity (212) and explain why the owner's instructions were not followed and may obtain a remote restart of the engines, if the owner accepts the presentation of why the boat appears not to be following the owner's instructions

If there is danger in stopping, due to weather, or other conditions, bilge pump failure as an example, the MBC EPS system will make a Danger report (796) and/or provide enough engine minutes to get to a safe dock or a safe harbor. The MBC EPS system will make whatever provisions the owner of the vessel provided to the EPS system in the event of a DANGER situation.

In the case of an unauthorized user, or a failure to identify the user, the owner may elect to send a theft report (795). In such case the MBC server choses local authorities to receive the report based upon GPS location of the vessel.

The engine will not restart without more SEC or electronic fuel, in the next section, (Transmit more SEC to Motor 850), instructions are provided if the engine is not stolen, but is in the hands of an owner approved maintenance tech.

Transmit more SEC to Motor 850

Once disconnected from the boat, the motor cannot be given more “engine on time” without a qualified maintenance engineer attaching a cell phone to the GPS/Wi-Fi unit via an on-board USB connector. With the owner online, a command interior to the owner's app can be sent to the engine to restart the engine for testing or maintenance evaluation purposes.

As the engine has an on-board GPS unit 585, or 615, or 620 any of which have battery assistance to continue providing GPS location information. The onboard GPS unit is connected to a Wi-Fi seeker system Unit 895. If the thieves or thief take the outboard engine into an area with Wi-Fi, the onboard GPS will provide its location to MBC. MBC will provide this GPS information date and time to local authorities if the owner of the boat has agreed to this step.

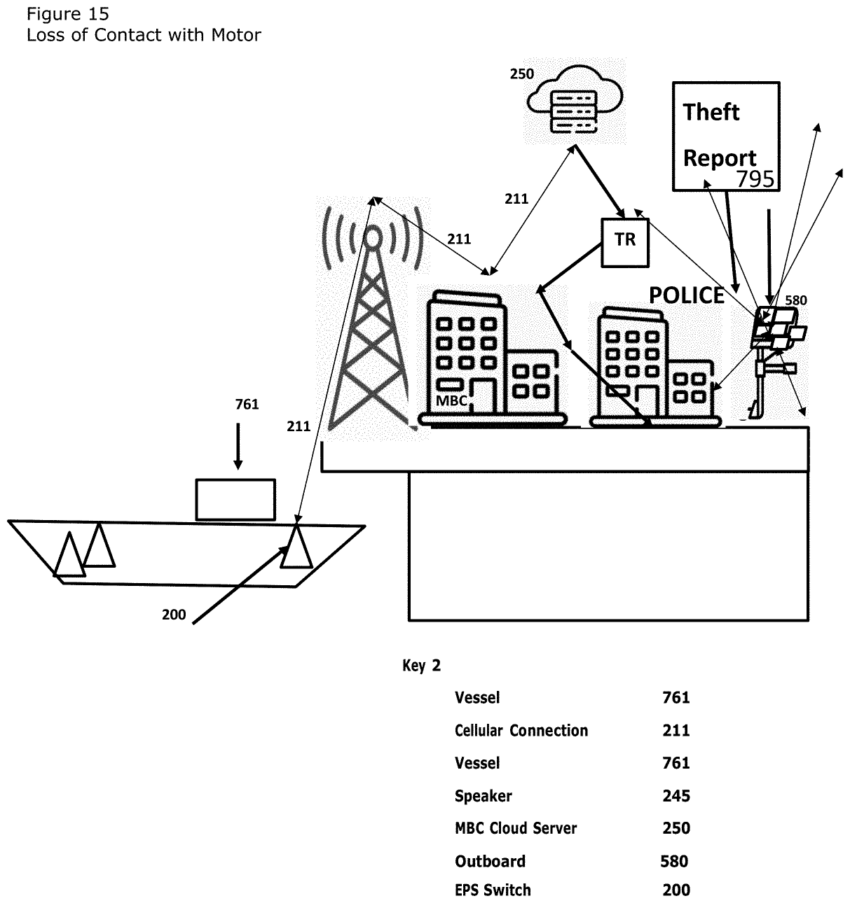

Referring now to FIG. 15, in an embodiment, a method provides for Reporting loss of contact with motor 890. As the engine has an on-board GPS unit 585, or 615, or 620 any of which have battery assistance to continue providing GPS location information. The onboard GPS unit is connected to a Wi-Fi seeker system Unit 895. If the thieves or thief take the outboard engine into an area with Wi-Fi, the onboard GPS will provide its location to MBC. MBC will provide this GPS information date and time to local authorities if the owner of the boat has agreed to this step.

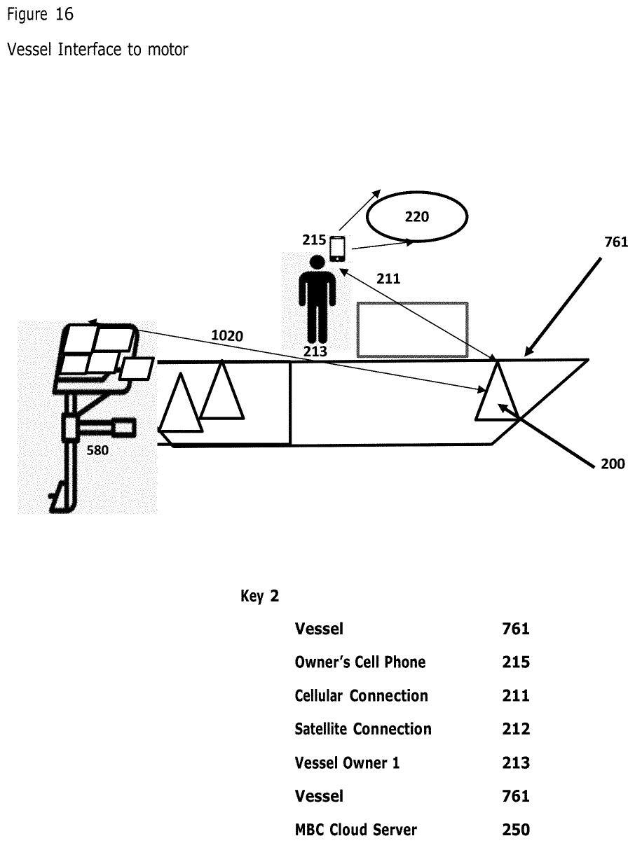

Referring now to FIG. 16 in an embodiment, Interface to motor 910 The interface to motor 910 takes place via Bluetooth unit 755. The Bluetooth unit can only connect to the vessel via the vessel EPS unit, if the engine remains attached to the vessel. Bluetooth can make connections over limited distance. No thief would disconnect an engine and then wait around close enough to the boat to allow the Bluetooth connection to be maintained. So, if an engine disconnect alert is sent, it is likely the loss of an engine.

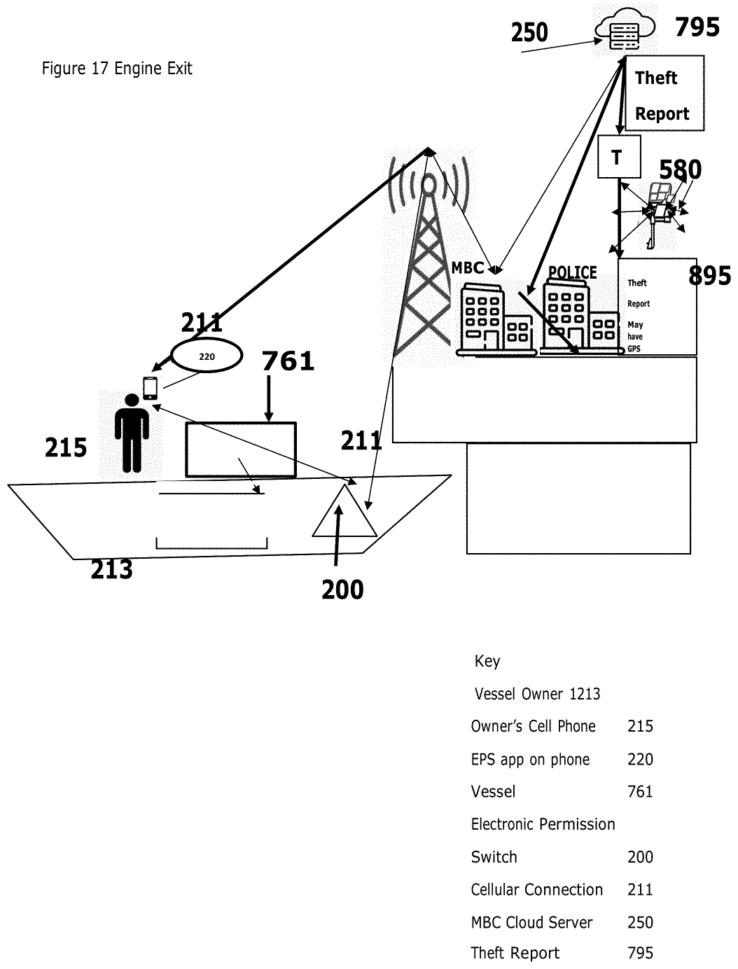

Referring now to FIG. 17 in an embodiment, If the engine is removed, the owner (Unit O1) receives a report of engine separation from the MBC Cloud Server. The engine has limited battery power on board and has a Wi-Fi Unit 895. This unit will seek Wi-Fi and will make a GPS report if Wi-Fi is connected to the engine. Interface to MBC server is via Wi-Fi Unit 895 when the engine is removed from the vessel if the engine finds Wi-Fi available

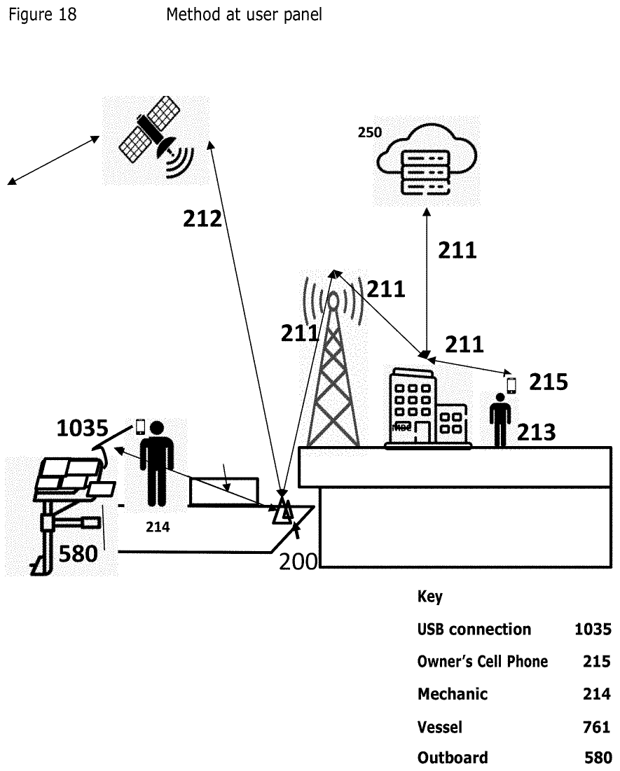

Referring to FIG. 18 describes a method at a user panel if the engine is properly connected to the vessel, the engine will continue to receive messages from the vessel EPS unit via Bluetooth connectivity (1020). The EPS unit is in two-way contact with the MBC Cloud Server. Messages for the engine leave the MNC Cloud Server, arrive at the EPS unit, via cellular connectivity, and travel to the engine via Bluetooth connectivity.

The MBC Cloud Server is connected to the MBC customer via cellular connectivity. If the owner does not provide real time instructions to the MBC Cloud Server, the MBC will follow the last instructions given by the owner. These instructions will be provided as appropriate to the vessel EPS system, The EPS will provide these instructions to the engine. The owner can connect to a disconnected engine if a qualified maintenance engineer provides a USB connection 1035 between the engine and the engineers cell phone, and if the engineer calls the cell phone of the owner. At this time, the owner can provide communications to the engine via the MBC app on the owner's cell phone.

### Add SEC to MBC 1050

The owner can connect to a disconnected engine via the method described in section 1010. Once the connection is made, the owner can add SEC if he chooses.

### Forcing SEC to Zero 1090.

The owner, via the method described in section 1010 can force the SEC on board the engine to zero.

### Embodiments of the Invention

One aspect of the invention is a system comprising: a time/location service 230; a Pulse generator 240; a distributed ledger at plurality of marine blockchain servers 250; a propulsive motor 270; and a maritime vessel 290.

In an embodiment, the system also includes an Engine Permission Switch (EPS) 200 apparatus comprising a cellular data unit 205; a satellite phone link 208; and a location data unit 235 e.g. cellular, satellite, Galileo, Global Positioning System, radio triangulation, navigation system; configured to obtain control signals from marine blockchain server 250.

In an embodiment, the system also includes a distributed blockchain contract (Marine Blockchain) process comprising: triggering an alert when location indicia of motor and vessel diverge; decrementing a Sec counter based on time and location indicia received from EPS 200; initiating warnings, requests, and engine shutdown when Sec counter value decrements to trigger values; performing contract instructions agreed by stakeholders on location, operation, maintenance, finance, and safety which cause engine control processes, wherein a Sec is a measure of time and of nautical location displacement e.g. a fraction of a nautical mile.

In an embodiment, said stakeholders comprise at least two of owners, operators, manufacturers, maintainers, regulators, insurers, lien holders, location service providers, harbors, and dockyards of at least one of an engine and a maritime vessel.

In an embodiment, said motor comprises a location data unit 585, 615, or 620.

### Conclusion

The object of the invention is to integrate all the manufacturing, operation, and maintenance history of a maritime vessel and its propulsive motor in an immutable record which enforces contractual agreements by metering an electronic fuel measured in time and nautical displacement. Rather than deny the engine any of the traditional components feeding the engine reaction that produces power, via some hidden off switch, the requirement that the engine now requires electronic fuel means that if a thief were to find the engine permission system unit and disconnect it from the vessel, or from the engine (s) on board the vessel, the engine (s) would not start, making theft of the boat more difficult, (it would require a towboat to complete the theft) and making resale of the engines less desirable. In one instance of this EPS system the manufacturers of boat engines license this patent and arrange their engines to seek this electronic fuel as an option available to be set by an authorized dealer.

### Benefits

The owner may contract within the Marine Blockchain to deny electronic fuel to the boat whenever a manufacturer's recall is of a level of seriousness that use of the boat could create a risk of injury to the owner or the owner's family. Therefore, there can be owner contracted situations, with owner's full knowledge, where the Marine Blockchain would deny start up of the vessel, even if the owner desired the start up.

In another application, an insurance company may deny electronic fuel to this vessel until certain survey recommendations have been completed by a competent repair facility.

In a financial application, if the owner is a borderline economic risk the lender may require an automatic “repossession of the financed boat” via the MBC system denial of electronic fuel due to non-payment of a loan payment when due. In such case, the owner would not be able to start the boat

without lender release sent to MBC in a legal manner.

In a risk control application, a problem condition and location can be transmitted to the Marine Blockchain system on conditions such as when captain was to become incapacitated, or a tracked lifesaving subsystem on the boat were malfunctioning.

In another risk control situation, the bilge pump on a vessel which activates above a threshold of normal duty could cause an alert.

Location for storage or custody of the vessel may be contracted until a release transaction is recorded into the Marine Blockchain.

The invention can be easily distinguished from pure database record keeping because a third party must enforce any obligation.

### An Exemplary Suitable Operating Environment: Computing Device

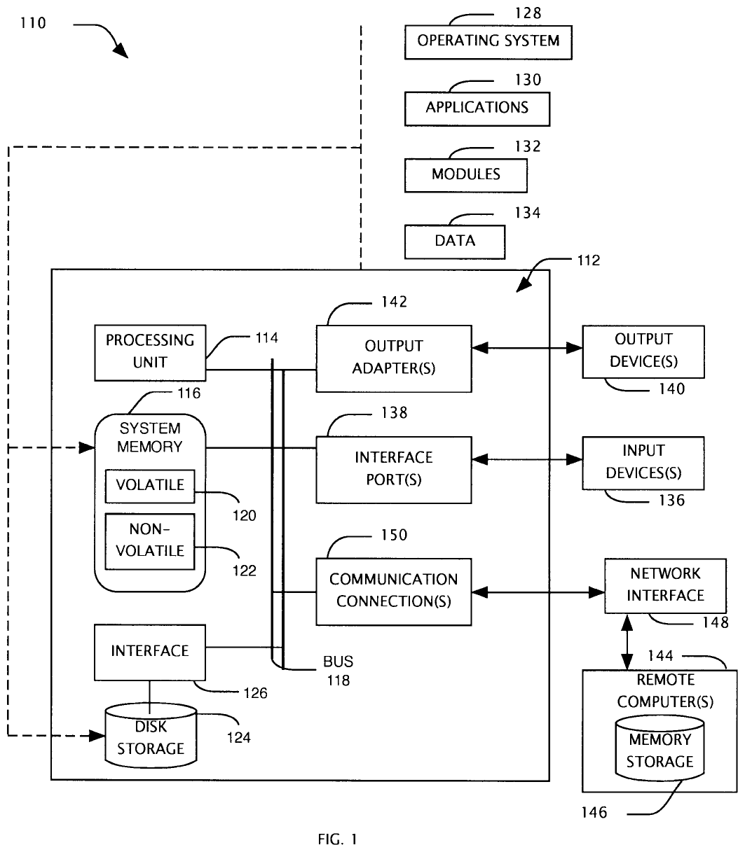

In order to provide additional context for various aspects of the subject invention, FIG. 1 and the following discussion are intended to provide a brief, general description of a suitable operating environment 110 in which various aspects of the subject invention may be implemented. While the invention is described in the general context of computer-executable instructions, such as program modules, executed by one or more computers, processors, or other devices, those skilled in the art will recognize that the invention can also be implemented in combination with other circuits, program modules, and/or as a combination of hardware and software.

Generally, however, program modules include routines, programs, objects, components, data structures, etc. that perform particular tasks or implement particular data types. The operating environment 110 is only one example of a suitable operating environment and is not intended to suggest any limitation as to the scope of use or functionality of the invention. Other well known computer systems, environments, and/or configurations that may be suitable for use with the invention include but are not limited to, mobile phones, tablets, cloud servers, gaming devices, displays, identity credentials and their readers, cameras, attire, vehicles, medical devices, watches, robots, security instruments, weapons systems, entertainment devices, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 1, an exemplary environment 110 for implementing various aspects of the invention includes a computer 112. The computer 112 includes a processing unit 114, a system memory 116, and a system bus 118. The system bus 118 couples system components including, but not limited to, the system memory 116 to the processing unit 114. The processing unit 114 can be any of various available processors. Dual microprocessors and multi-core architectures also can be employed as the processing unit 114. Within this application the term “processor” also refers to implementations of 112 in highly integrated embodiments.

The system bus 118 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 116 includes volatile memory 120 and nonvolatile memory 122. The basic input/output system (BIOS), containing the basic routines to transfer information between elements within the computer 112, such as during start-up, is stored in nonvolatile memory 122. By way of illustration, and not limitation, nonvolatile memory 122 can include read only memory (ROM), programmable ROM (PROM), electrically programmable ROM (EPROM), electrically erasable ROM (EEPROM), or flash memory. Volatile memory 120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 112 also includes removable/nonremovable, volatile/nonvolatile computer storage media. FIG. 1 illustrates, for example a disk storage 124. Disk storage 124 includes, but is not limited to, devices like a magnetic disk drive, floppy disk drive, solid state drive, flash memory card, or memory stick. In addition, disk storage 124 can include storage media separately or in combination with other storage media including, but not limited to, network storage, array of disks, or quantum storage. To facilitate connection of the disk storage devices 124 to the system bus 118, a removable or non-removable interface is typically used such as interface 126.

It is to be appreciated that FIG. 1 describes software that acts as an intermediary between users and the basic computer resources described in suitable operating environment 110. Such software includes an operating system 128. Operating system 128, which can be stored on non-transitory media such as disk storage 124, acts to control and allocate resources of the computer system 112. System applications 130 take advantage of the management of resources by operating system 128 through program modules 132 and program data 134 stored either in system memory 116 or on disk storage 124. It is to be appreciated that the subject invention can be implemented with various operating systems or combinations of operating systems, virtual machines, and virtual machine images.

A user enters commands or information into the computer 112 through input device(s) 136. Input devices 136 include, but are not limited to, a radio, magnetic, or optical scanner, a pointing device such as, mouse, trackball, stylus, touch pad, keyboard, microphone, joystick, game pad, satellite dish, scanner, TV tuner card, digital camera, digital video camera, web camera, and the like. These and other input devices connect to the processing unit 114 through the system bus 118 via interface port(s) 138. Interface port(s) 138 include, for example, HDMI, a serial port, a parallel port, a game port, and a universal serial bus (USB). Output device(s) 140 use some of the same type of ports as input device(s) 136. Thus, for example, a USB port may be used to provide input to computer 112, and to output information from computer 112 to an output device 140. Output adapter 142 is provided to illustrate that there are some output devices 140 like High Definition Televisions (HDTV), monitors, speakers, and printers among other output devices 140 that require special adapters. The output adapters 142 include, by way of illustration and not limitation, video and sound cards that provide a means of connection between the output device 140 and the system bus 118. It should be noted that other devices and/or systems of devices provide both input and output capabilities such as remote computer(s) 144.

Computer 112 can operate in a networked environment using logical connections to one or more remote computers, such as remote computer(s) 144. The remote computer(s) 144 can be a cloud service, personal computer, a server, a router, a network PC, a workstation, a microprocessor based appliance, a peer device or other common network node and the like, and typically includes many or all of the elements described relative to computer 112. For purposes of brevity, only a memory storage device 146 is illustrated with remote computer(s) 144. Remote computer(s) 144 is logically connected to computer 112 through a network interface 148 and then physically connected via communication connection 150. Network interface 148 encompasses communication networks such as cellular data, Wi-Fi, Bluetooth, Near Field Communications, local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, mesh, IP, point-to-point links, circuit switching networks like Integrated Services Digital Networks (ISDN) and variations thereon, packet switching networks, and Digital Subscriber Lines (DSL).

Communication connection(s) 150 refers to the hardware/software employed to connect the network interface 148 to the bus 118. While communication connection 150 is shown for illustrative clarity inside computer 112, it can also be external to computer 112. The hardware/software necessary for connection to the network interface 148 includes, for exemplary purposes only, internal and external technologies such as, modems including satellite, 802.11, CDMA, regular telephone grade modems, cable modems and DSL modems, ISDN adapters, and Ethernet cards.

### Spirit and Scope of the Appended Claims

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

We claim:

1. A system comprising:
a time/location service;
a pulse generator;
a distributed ledger at plurality of marine blockchain servers;
a propulsive motor; and
a maritime vessel, all communicatively coupled.

2. The system of claim 1 further comprising an Engine Permission Switch (EPS) apparatus comprising:
a cellular data unit;
a satellite phone link; and
a location data unit; configured to obtain control signals from at least one of the marine blockchain servers.

3. The system of claim 1 further comprising a distributed blockchain contract (Marine Blockchain) process comprising:
triggering an alert when location indicia of the propulsive motor and the maritime vessel diverge;
decrementing a Sec counter based on time and location indicia received from EPS;
initiating warnings, requests, and engine shutdown when Sec counter value decrements to trigger values;
performing contract instructions agreed by stakeholders on location, operation, maintenance, finance, and safety which cause engine control processes, wherein Sec is a measure of time and of nautical location displacement.

4. The system of claim 3 wherein said stakeholders comprise:
at least two of owners, operators, manufacturers, maintainers, regulators, insurers, lien holders, location service providers, harbors, and dockyards of,
at least one of a propulsive motor and a maritime vessel.

5. The system of claim 1 wherein said propulsive motor comprises a location data unit.
